(19) United States
(12) Patent Application Publication
(10) Pub. No.: US 2026/0116833 A1
(43) Pub. Date: Apr. 30, 2026

(54) FERTILIZER AND SYSTEMS AND METHODS FOR PREPARING THE SAME

(71) Applicant: Replenish Nutrients, LTD., Okotoks (CA)

(72) Inventors: Kevin Erickson, Okotoks (CA); Neil Wiens, Okotoks (CA)

(73) Assignee: Replenish Nutrients, LTD., Okotoks, AB (CA)

(21) Appl. No.: 19/149,837

(22) PCT Filed: Jan. 22, 2024
(86) PCT No.: PCT/IB2024/000052

§ 371 Date: Jul. 21, 2025

Related U.S. Application Data
(60) Provisional application No. 63/481,015, filed on Jan. 23, 2023.

(51) Int. Cl. C05F 11/08; C05B 17/00; C05D 1/00; C05D 9/00; C05G 5/12; C05G 5/30; C05G 5/40

(52) U.S. Cl. CPC C05F 11/08; C05B 17/00; C05D 1/005; C05D 9/00; C05G 5/12; C05G 5/30; C05G 5/40

(57) ABSTRACT

The present disclosure concerns the preparation of a fertilizer. In various embodiments, a system and method for preparing a fertilizer may include mixing biologically organic material and elemental sulphur with at least one of a rock phosphate and a potash to form a mixture, wherein the biologically organic material comprises solubilizing microbes. The method may include solubilizing the rock phosphate and the elemental sulphur in the mixture using the solubilizing microbes; mechanically micronizing the mixture to a particle size between about 1 μm and about 250 μm; forming the micronized mixture into a bio-nutrient granule; and removing moisture from the bio-nutrient granule, wherein a surface temperature of the bio-nutrient granule does not exceed 180° F. A fertilizer and system for making the fertilizer according to this method are also disclosed.

### TECHNICAL FIELD

The present disclosure relates to fertilizers, and in particular to preparing granulated, biologically-active, mineral-based fertilizers.

### BACKGROUND

Fertilizers may be used to improve soil quality in various areas, including broader agricultural applications. Various minerals and biologically-active material can be incorporated into a fertilizer in order to improve deficiencies in soil health. The fertilizer may then be mixed with the soil.

Minerals and biologically-active material are mixed with soil for a variety of functions, including retaining water and moisture, elevating soil temperature, controlling weeds, adding nutrients, allowing water to drain from the soil, controlling pests such as insects, bacteria, and fungi, and other functions conducive to supporting soil and plant health.

Chemical fertilizer applications are available in a variety of forms. One of the most common forms is a granulated formulation that creates a synthetic salt that depletes the soil of key nutrients, biological material and minerals. Over time, the composition of the soil becomes depleted and additional nutrients, minerals and biological matter are needed.

Rock phosphate, potash (potassium chloride) and elemental sulphur are key mineral nutrients to plant and soil health. Rock phosphate and elemental sulphur depend on microbial colonization to become plant available through biochemistry.

Although rock phosphate and elemental sulphur require microbial processing in order to become plant-available, some soils do not contain the required microbial profile. Additionally, the processing of these mineral sources by microbes is dependent on the available surface area of the mineral. A smaller particle size increases the surface area and allows microbes to convert the minerals more quickly to a plant-available form.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures:

FIG. 1 illustrates a flow chart for a method of preparing a fertilizer.

FIG. 2 illustrates a block diagram of a system for preparing a fertilizer.

FIG. 3 illustrates a system for performing a method for preparing a fertilizer.

### SUMMARY OF THE INVENTION

In accordance with an example embodiment, a method for preparing a fertilizer is disclosed. The method may comprise: mixing a biologically organic material and elemental sulphur with at least one of the rock phosphate and potash to form a mixture, wherein the biologically organic material comprises solubilizing microbes; curing the elemental sulphur and at least one of rock phosphate and potash, in the mixture, using the solubilizing microbes, resulting in a production of organic acids and plant-available nutrients in the mixture; mechanically micronizing the mixture to a particle size between about 1 μm and about 250 μm; forming the mixture into a bio-nutrient granule having a size between about 1 mm and 4 mm in diameter; and removing moisture from the bio-nutrient granule, wherein a surface temperature of the bio-nutrient granule does not exceed 180° F.

In accordance with an example embodiment, a fertilizer is disclosed. The fertilizer may comprise: bio-nutrient granules, each bio-nutrient granule comprising a biologically organic material, elemental sulphur, and at least one of rock phosphate and potash; wherein the biologically organic material comprises living solubilizing microbes; and wherein each bio-nutrient granule comprises (in terms of percent by weight of the coated dried bio-nutrient granules): between about 1% to 3% of a binder; between about 1% of a coating; and one of: (A) where the bio-nutrient granules comprise a biologically organic material, elemental sulphur and rock phosphate: the biologically organic material: about 1% to 15%; the rock phosphate: about 60%-80%; the elemental sulphur: about 5%-20%; (B) where the bio-nutrient granules comprise a biologically organic material, elemental sulphur and potash: the biologically organic material: about 1% to 15%; the potash: about 30%-50%; the elemental sulphur: about 20%-40%; or (C) where the bio-nutrient granules comprise a biologically organic material, elemental sulphur, rock phosphate and potash: the biologically organic material: about 1% to 15%; the rock phosphate: about 30%-50%; the potash: about 20%-40%; and the elemental sulphur: about 20%-35%.

In accordance with an example embodiment, a system for preparing a fertilizer is disclosed. The system may comprise: a mixer for mixing a biologically organic material with elemental sulphur and at least one of rock phosphate and potash, to form a mixture; a micronizer operably connected to the mixer, wherein the micronizer receives the mixture and micronizes the mixture to form a micronized mixture; a granulator operably connected to the micronizer, wherein the granulator forms the micronized mixture into bio-nutrient granules; and a granule dryer operably connected to the granulator for receiving the bio-nutrient granules from the granulator, wherein the granule dryer removes moisture from the bio-nutrient granules, and wherein a surface temperature of the bio-nutrient granules does not exceed 180° F. during this moisture removing process.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the principles of the present disclosure, it should be understood that other embodiments may be realized and that logical changes and adaptations in design and construction may be made in accordance with principles of the present disclosure. Thus, the detailed description herein is presented for purposes of illustration only and not of limitation. For example, steps recited in any of the method or process descriptions may be executed in any suitable order and are not necessarily limited to the order presented. Furthermore, any reference to singular includes plural embodiments, and any reference to more than one component or step may include a singular embodiment or step.

For the sake of brevity, conventional techniques for preparing fertilizers and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method for forming fertilizers, related methods, and/or products arising therefrom.

The present disclosure concerns the preparation of a fertilizer. In various embodiments, a method for preparing a fertilizer may include mixing biologically organic material (such as compost) with elemental sulphur and at least one of rock phosphate and potash (e.g. potassium chloride) to form a mixture. The method may further comprise mixing certain other additives with the biologically organic material to form the mixture. In various embodiments, the biologically organic material includes solubilizing microbes. In various exemplary embodiments, the method may include solubilizing the rock phosphate, potash, elemental sulphur and any additives in the mixture using the solubilizing microbes, resulting in the production of organic acids and plant-available nutrients. The method may further comprise micronizing the mixture, drying the mixture, and forming granules from the dried mixture.

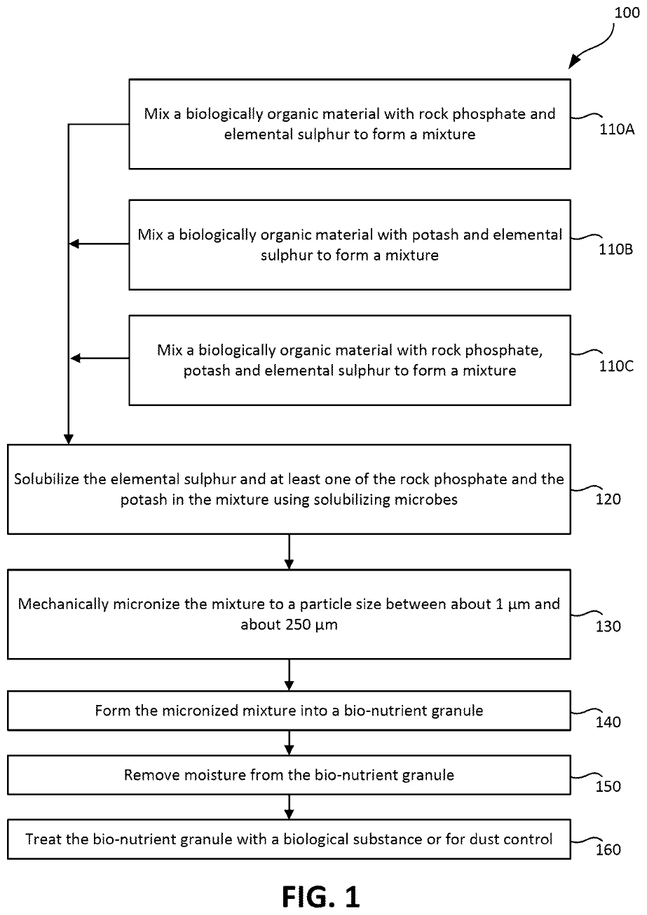

With reference now to FIG. 1, a flow chart is illustrated of an example method 100 for preparing a fertilizer. In various embodiments, the method may include mixing a biologically organic material and elemental sulphur and at least one of rock phosphate and potash (e.g. potassium chloride) to form a mixture. For example, the method may include mixing a biologically organic material and elemental sulphur with rock phosphate (110A) to form a mixture. In another example embodiment, the method may include mixing a biologically organic material and elemental sulphur with potash (110B) to form a mixture. In another example embodiment, the method may include mixing a biologically organic material and elemental sulphur with rock phosphate and potash (110C) to form a mixture. In an example embodiment, the mixing may be performed using a mixer, e.g., a pin mixer, a trommel screener, or any suitable mixing device or process.

In accordance with an example embodiment, the biologically organic material may comprise a compost or seaweed extract. In another example embodiment, the “biologically organic material” may comprise nutrient-rich, dirt-like material produced when organic matter, including food scraps, plant matter, animal products, seaweed extract, or similar substances, decomposed under certain conditions. In example embodiments, the biologically organic material is referred to herein as ‘compost.’ In an example embodiment, the biologically organic material comprises solubilizing microbes. In an example embodiment, the biologically organic material is biologically active.

In accordance with an example embodiment, ‘potash’ may comprise at least one of potassium chloride, potassium sulfate, potassium nitrate, or potassium carbonate. Moreover, any suitable potash may be used.

In accordance with an example embodiment, “elemental sulphur” may comprise a composition containing about 99% elemental sulphur.

As used herein, “microbes” means microorganisms, fungi, bacteria, actinomycetes, and/or the like.

The method 100 may further comprise mixing in additives to form the mixture. In an example embodiment, the additives may comprise at least one of boron, humate, lime and calcium. Moreover, any suitable additives may be used. It is noted that the rock phosphate itself may comprise one or more of boron, lime, calcium and various micronutrients, but the additives are adding one or more of these beyond any amount already present, if any, in the rock phosphate.

In various embodiments, the method 100 may include solubilizing the elemental sulphur and at least one of the rock phosphate and potash (and optionally any additives in the mixture) using the solubilizing microbes (120). In an example embodiment, this solubilizing may result in the production of organic acids and plant-available nutrients.

The method 100 may further comprise micronizing (130) the mixture. In various embodiments, the mixture may be mechanically micronized to a particle size between about 1 μm and about 250 μm. In an example embodiment, the mixture may be mechanically micronized using grinding equipment such as a ball mill, a hammer mill, a pendulum mill, a roller mill or the like.

The method 100 may further include forming the micronized mixture into a bio-nutrient granule (140). The micronizer may be, for example, a ball mill or any suitable micronizer. In various embodiments, the method 100 may include removing moisture from the bio-nutrient granule (150). In an example embodiment, the moisture removal is performed such that a surface temperature of the bio-nutrient granule does not exceed 180° F. In accordance with an example embodiment, a product dryer is used to remove the moisture from the bio-nutrient granule.

The method 100 may include the application of a coating to the bio-nutrient granule (160). The coating may comprise coating of a biological substance on the bio-nutrient granules. Moreover, any suitable biological substance may be used to coat the bio-nutrient granules. In an example embodiment, coating may comprise coating the bio-nutrient granules with a dust control and/or anti-coating agent. The coating process may be performed by a drum coater, a treater, and/or the like.

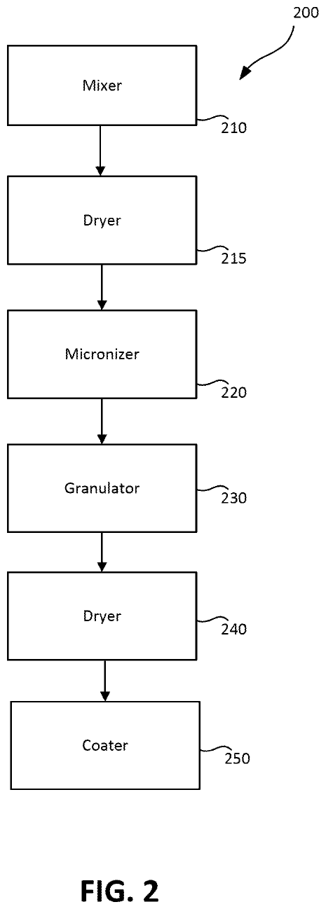

Referring now to FIG. 2, a block diagram of a system 200 is illustrated. The system 200 may be configured to perform the method of preparing a fertilizer. In accordance with an example embodiment, system 200 comprises: mixer 210, a product dryer 215 (similar to product dryer 306 below), a micronizer 220, a granulator 230, a granule dryer 240, and a coater 250 (or treater) (similar to coater 344 below).

In various example embodiments, mixer 210 may be configured to receive biologically organic material and elemental sulphur and at least one of rock phosphate and potash. Mixer 210 may be configured to mix the biologically organic material and elemental sulphur and at least one of rock phosphate and potash to form a mixture. Moreover, the mixer 210 may be configured to receive at least one additive (e.g., boron, humate, lime and calcium) and to mix the at least one additive with the other components. Mixer 210 may further be configured to output the mixture. In accordance with an example embodiment, the mixer 210 comprises a mixer, e.g., a pin mixer, a trommel screener, or any suitable device for blending or mixing components into a homogenous blend. In accordance with an example embodiment, the mixture may be solubilized after the mixing occurs. In an example embodiment, the solubilization occurs in a blended material stockpile after the mixer has mixed the input materials.

In various example embodiments, micronizer 220 may be operably connected to mixer 210, such that the contents of mixer 210 may be transferred into micronizer 220. Stated another way, micronizer 220 may be configured to receive the mixture output from mixer 210 (after the solubilization step occurring therebetween). Micronizer 220 may further be configured to micronize the mixture. Micronizer 220 may further be configured to output the micronized mixture. In various embodiments, micronizer 220 may include a ball mill, a hammer mill, a pendulum mill, or a roller mill. Moreover, micronizer 220 may comprise any suitable device for micronizing the output of mixer 210.

In various embodiments, granulator 230 may be operably connected to micronizer 220, such that the contents of micronizer 220 may be transferred into granulator 230. Stated another way, granulator 230 may be configured to receive a micronized mixture from micronizer 220. Granulator 230 may further be configured to granulate the micronized mixture into bio-nutrient granules. Granulator 230 may further be configured to output the bio-nutrient granules. Moreover, granulator 230 may comprise any suitable device for granulation. In accordance with a further example embodiment, forming the mixture into the bio-nutrient granule comprises using a binder to agglomerate the mixture into the bio-nutrient granule.

In various embodiments, a granule dryer 240 may be operably connected to granulator 230, such that the contents of granulator 230 may be transferred into granule dryer 240. Stated another way, granule dryer 240 may be configured to receive the bio-nutrient granules from granulator 230. Granule dryer 240 may further be configured to dry the bio-nutrient granules. Granule dryer 240 may be configured to output the dried bio-nutrient granules. In various embodiments, granule dryer 240 may include a fluid bed dryer. Moreover, granule dryer 240 may comprise any suitable device for removing moisture from bio-nutrient granules to an acceptable moisture content. In accordance with one example embodiment, the granule dryer 240 comprises an indirect heat source such as a fluid bed dryer, drum dryer, belt dryer, or the like.

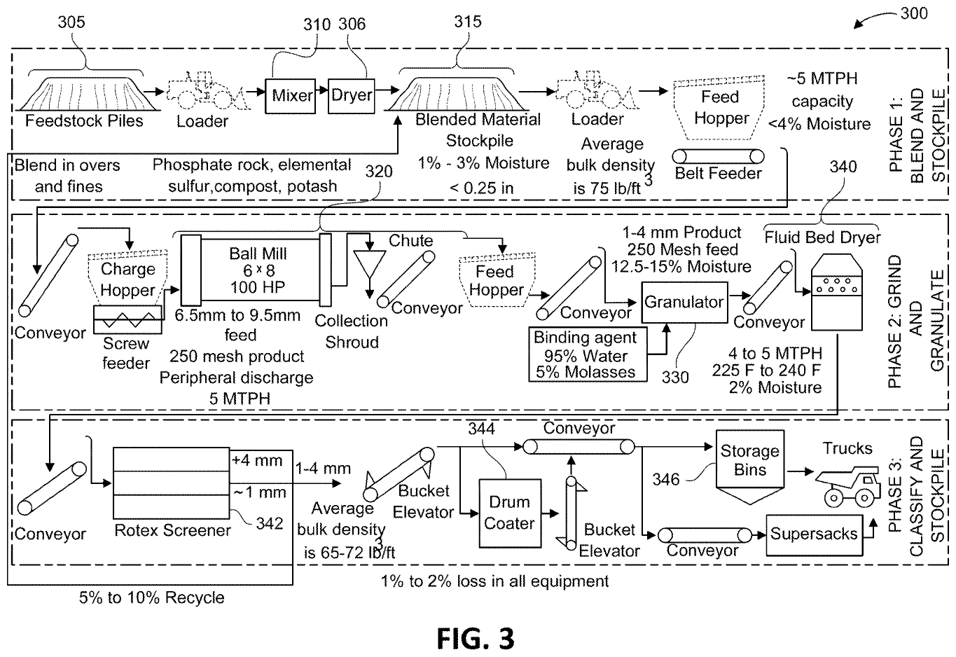

Referring now to FIG. 3, an example system 300 for preparing a fertilizer, is illustrated. In accordance with an example embodiment, system 300 comprises: a mixer 310, a micronizer 320, a granulator 330, and a coater 344, as described in more detail below.

System 300 may further comprise a plurality of feedstock piles 305. The feedstock piles 305 may comprise piles of product. In an example embodiment, each feedstock pile is a separate product or grade of product. In accordance with various example embodiments, one feedstock pile may comprise biologically organic material, another feedstock pile may comprise rock phosphate, another feedstock pile may comprise elemental sulphur, and another feedstock pile may comprise potash. Moreover, another feedstock pile may comprise additives as described further herein. Moreover, any suitable product may be placed in one or more feedstock piles of the plurality of feedstock piles 305, for use in conjunction with the system 300. In an example embodiment, the product in the feedstock piles is source material, suitable for input to the processing of system 300. Though described herein in connection with feedstock piles, the present disclosure contemplates that product may arrive ‘just in time’ or may be input to system 300 without being first placed in piles.

In an example embodiment, system 300 comprises a mixer 310. Mixer 310 is configured to receive the source material from the various feedstock piles 305. The source material may be moved from the feedstock piles 305 to the mixer 310 using a loader. Moreover, a loader may be used at any suitable transfer of materials from one component of system 300 to another. However, in various example embodiments, the materials may move from one component of system 300 to another via gravity fed hoppers and/or conveyor belts, or other suitable material conveyance devices. Moreover, any suitable method for transferring the various materials from one component to another may be used.

In an example embodiment, the mixer 310 is configured to mix or blend the products input into the mixer 310 and output a mixture. The mixture may be stored in a blended material stockpile 315. Thus, mixer 310 may be operably connected between the plurality of feedstock piles 305 and the blended material stockpile 315, such that the contents of mixer 310 may be received from the feedstock piles 305, mixed, and then transferred into the blended material stockpile 315.

In an example embodiment, mixer 310 may be configured to receive biologically organic material and elemental sulphur and at least one of rock phosphate and potash. In various embodiments, mixer 310 may be configured to mix a biologically organic material and elemental sulphur and at least one of rock phosphate and potash (e.g. potassium chloride) to form a mixture. For example, mixer 310 may be configured to mix a biologically organic material and elemental sulphur with rock phosphate to form a mixture. In another example embodiment, mixer 310 may be configured to mix a biologically organic material and elemental sulphur with potash to form a mixture. In another example embodiment, mixer 310 may be configured to mix a biologically organic material and elemental sulphur with rock phosphate and potash to form a mixture. Mixer 310 may then output the mixture.

In a further example embodiment, the mixer 310 may be further configured to mix the biologically organic material with at least one additive. Example, additives may include boron, humate, lime and calcium, though other suitable additives may be used. The additives may be provided from feedstock piles, supply tanks, and/or the like.

In one example embodiment, mixer 310 comprises a pin mixer, a trommel screener or any suitable mixing device or process. For example, in one example embodiment, the mixer simply comprises the loaders mixing the source material together.

In an example embodiment, system 300 may further comprise a product dryer 306 (similar to product dryer 215). The product dryer 306 may be configured to receive the mixture from the mixer 310, to dry the source material prior to further processing, and to provide the dried mixture to the blended material stockpile 315. In various embodiments, product dryer 306 may heat the bio-nutrient granules to have a surface temperature of no more than 180° F. In an example embodiment, the surface temperature is limited to avoid the killing of any biological material. In various example embodiments, the product dryer 306 comprises an indirect heat source such as a fluid bed dryer, drum dryer, belt dryer, or equipment similar in nature.

In an example embodiment, therefore, the blended material stockpile 315 may contain a blend comprising biologically organic material, elemental sulphur and at least one of rock phosphate and potash. In various example embodiments, other suitable blends may be used in accordance with this disclosure.

In various embodiments, the contents of blended material stockpile 315 may undergo a curing process. In such embodiments, the contents of the mixture in the blended material stockpile 315 may include solubilizing microbes. The solubilizing microbes may originate from biologically organic material. In various embodiments, the solubilizing microbes may produce organic acids. In various embodiments, the organic acids may react with the contents of blended material stockpile 315. In various embodiments, the curing process may result in a decrease in pH of the mixture. In various embodiments, the pH of the contents of the blended material stockpile 315 may begin at between about 6.5 and about 7.8. After the curing process, the pH of the contents of the blended material stockpile 315 may decrease to between about 4.2 and about 6.8. Stated another way, in various example embodiments, the biologically organic material in the mixture triggers the reaction and starts the conversion of elemental sulphur into a sulphate, which then in turn releases the other nutrients to a form that is readily available for plant uptake. Stated another way, the curing process can occur solely through biological processes and not through adding external sulphuric acid to the process.

In various embodiments, blended material stockpile 315 may be operably connected to micronizer 320, such that the contents of blended material stockpile 315 may be transferred into micronizer 320. The contents of blended material stockpile 315 may be transferred into micronizer 320 using a loader. The contents of blended material stockpile 315 may be transferred into micronizer 320 using at least one of a feed hopper, a belt feeder, a conveyor, a charge hopper, and a screw feeder. Moreover, any suitable methods may be used to transfer the contents of blended material stockpile 315 to micronizer 320.

Micronizer 320 may be configured to receive a mixture comprising the biologically organic material, elemental sulphur, and at least one of rock phosphate and potash, to micronize the mixture, and then to output the micronized mixture. In various embodiments, micronizer 320 may comprise a ball mill. In various embodiments, micronizer 320 may comprise a hammer mill, a pendulum mill, a roller mill, and/or the like. In various embodiments, micronizer 320 may be configured to output particles sized between about 1 μm and about 250 μm.

In various embodiments, micronizer 320 may be operably connected to granulator 330, such that the output of micronizer 320 may be transferred into granulator 330. The output of micronizer 320 may be transferred into granulator 330 using at least one of a feed hopper, a conveyor, a chute, and/or any suitable method of conveyance of the micronized material.

Granulator 330 may be configured to receive a micronized mixture, granulate the micronized mixture into bio-nutrient granules, and then output the bio-nutrient granules. In various embodiments, the bio-nutrient granules may include granules with a size of between about 1 mm and about 4 mm in diameter.

In accordance with various example embodiments, the granulator 330 may be configured to add a binding agent to the micronized mixture in the process of forming the bio-nutrient granules. Thus, in an example embodiment, forming the mixture into the bio-nutrient granule comprises using a binder to agglomerate the mixture into the bio-nutrient granule.

In various embodiments, the granulator 330 may be configured to spray the binding agent on to the micronized mixture where the granules are formed through a mixing or tumbling action. Moreover, any suitable technique may be used for applying the binder to the micronized mixture to form the granules.

In various embodiments, the binding agent or “binder” may include an organic-based binder. In various embodiments, the organic-based binder may include at least one of molasses, a lignosulfate, a high carbohydrate binder or any binder capable of forming a stable granule. Moreover, the binding agent, “binder”, may comprise any food source suitable for feeding the solubilizing microbes. In an example embodiment, the binding agent may include about 95% water and about 5% molasses, though any suitable ratio may be used. The binding agent may be configured to facilitate the granulation of the micronized mixture in granulator 330.

In various embodiments, granulator 330 may be operably connected to a granule dryer 340, such that the output of granulator 330 may be transferred into granule dryer 340. The output of granulator 330 may be transferred into granule dryer 340 using at least one of a feed hopper, and a conveyor. Moreover, any suitable technique for conveyance of the granules to the granule dryer 340 may be used.

Granule dryer 340 may be configured to receive bio-nutrient granules, dry the bio-nutrient granules, and then output the dried bio-nutrient granules. In various embodiments, granule dryer 340 may comprise a fluid bed dryer passing air through a bed or layer of granules, drying the granules. In other example embodiments, the granule dryer 340 is a drum dryer that rotates and product falls through air passing through the drum dryer, drying the granules. Moreover, granule dryer 340 may comprise any suitable device for driving off moisture from the granules. In various embodiments, granule dryer 340 may dry the bio-nutrient granules via heating. In various embodiments, granule dryer 340 may heat the bio-nutrient granules to have a surface temperature of no more than 180° F. In an example embodiment, the surface temperature is limited to avoid the killing of any biological material. In various example embodiments, the granule dryer 340 comprises an indirect heat source such as a fluid bed dryer, drum dryer, belt dryer, or equipment similar in nature.

In various embodiments, granule dryer 340 may be operably connected to product screener 342, such that the output of granule dryer 340 may be transferred into product screener 342. The output of granule dryer 340 may be transferred using at least a conveyor or any suitable conveyance method.

Product screener 342 may be operably connected to the blended material stockpile 315, such that the output of product screener 342 may be transferred to blended material stockpile 315 if certain quality standards are not met. Product screener 342 may be configured to receive dried bio-nutrient granules, screen the dried bio-nutrient granules, and then output the screened bio-nutrient granules to coater 344 if certain quality standards are met, and output the screened mixture to blended material stockpile 315 if certain quality standards are not met. For example, the output of product screener 342 may be transferred to coater 344 if the bio-nutrient granules have the size between about 1 mm and about 4 mm. Otherwise, the output of product screener 342 may be transferred to blended material stockpile 315. Moreover, other quality standards or sizes may be used in this determination. In various embodiments, product screener 342 may include a vibratory screener, a deck screener, a rotary screener, e.g., a Rotex® screener, or any suitable screener.

In various embodiments, product screener 342 may be operably connected to coater 344 (similar to coater 250 above), such that the output of product screener 342 may be transferred to coater 344 if certain quality standards are met. The output of product screener 342 may be transferred to coater 344 using a bucket elevator, or any suitable transfer device.

Coater 344 may be configured to receive screened bio-nutrient granules, treat the screened bio-nutrient granules, and then output treated bio-nutrient granules. In various embodiments, the screened granules may be coated or treated with a dust suppressant. In various embodiments, the screened granules may be coated or treated with a biological substance. In various embodiments, the screened granules may be coated or treated with at least one of canola oil, Arkema coatings, humic acids, or an anti-caking agent. In various embodiments, the screened granules may be treated with a substance that enhances the biological activity of the screened granules. In various embodiments, coater 344 may include a drum coater, drum, belt, treater, pan treater or any suitable device for treating the bio-nutrient granules.

In various embodiments, coater 344 may be operably connected to storage receptacle 346, such that the output of coater 344 may be transferred to storage receptacle 346. The output of coater 344 may be transferred to storage receptacle 346 using at least one of a bucket elevator and a conveyor, or any other suitable conveyance device(s).

In various embodiments, storage receptacle 346 may be configured to receive the coated or treated granules. In various embodiments, storage receptacle 346 may include a storage bin or any suitable receptacle.

Moreover, various of the steps and components described herein may be performed remotely. For example, the various products may be micronized at a remote location, shipped to the site and mixed in their already micronized state.

### A Novel Fertilizer

Thus, in an example embodiment, the system 300 is configured to create a fertilizer. The fertilizer may include uniform, coated bio-nutrient granules. In a general example embodiment, fertilizer comprises coated granules comprising biologically organic material, elemental sulphur and at least one of rock phosphate and potash.

In various embodiments, each bio-nutrient granule may include a binder. The binder may include an organic-based binder. The organic-based binder may include at least one of molasses, a lignosulfate, or a high carbohydrate binder. In various embodiments, the organic-based binder may include any binder capable of forming a stable bio-nutrient granule.

In various embodiments, each bio-nutrient granule may also include a food source. In various embodiments, the binder may include a food source. In another example embodiment, the binder and/or the coating comprises the food source. The food source can be the molasses, for example, or any suitable food source for feeding the microbes. In various embodiments, the biologically organic material may include living solubilizing microbes. In an example embodiment, the organic material is biologically active.

In a first example embodiment, the coated granules comprise a biologically organic material, elemental sulphur and rock phosphate. In this example embodiment, the percent by weight of the coated dried granules is as follows:
The biologically organic material: about 1% to 15%
The rock phosphate: about 60%-80%
The elemental sulphur: about 5%-20%
The binder (e.g., the molasses): about 1%-3%
The coating: about 1%

In a second example embodiment, the coated granules comprise a biologically organic material, elemental sulphur and potash. In this example embodiment, the percent by weight of the coated dried granules is as follows:
The biologically organic material: about 1% to 15%
The potash: about 30%-50%
The elemental sulphur: about 20%-40%
The binder: about 1%-3%
The coating: about 1%

In a third example embodiment, the coated granules comprise a biologically organic material, elemental sulphur, rock phosphate and potash. In this example embodiment, the percent by weight of the coated dried granules is as follows:
The biologically organic material: about 1% to 15%
The rock phosphate: about 30%-50%
The potash: about 20%-40%
The elemental sulphur: about 20%-35%
The binder: about 1%-3%
The coating: about 1%

It is noted that the percentages above for the binder and coating are approximate ranges, and that the percentage could be fractionally less than 1% in some example embodiments.

In various embodiments, each bio-nutrient granule may include a crush strength of greater than about 2 newtons per square centimeter. In an example embodiment, each bio-nutrient granule may include a bulk density of between about 50 pounds per cubic foot and about 75 pounds per cubic foot. In an example embodiment, each bio-nutrient granule may include a pH of between about 3.5 and about 6.8. In an example embodiment, each bio-nutrient granule may include a porosity up to 70%. In an example embodiment, each bio-nutrient granule may include a diameter of between about 1 millimeter and about 4 millimeters. In an example embodiment, each bio-nutrient granule may be substantially round.

### WORKING EXAMPLE

The following example is intended to be purely illustrative, and not limiting of the present disclosure.

### Example 1

### Production of Bio-Nutrient Granules for a Fertilizer

Proof of concept experiments were performed to show the feasibility of creating bio-nutrient granules for use in a fertilizer.

A first feedstock pile comprising rock phosphate, biologically organic material, and elemental sulphur was created. The ratio of rock phosphate to elemental sulphur may be between 2:1 to 4:1, in an example embodiment, though any suitable ratio may be used. The biologically organic material comprised a solubilizing microbe. In this example embodiment, the solubilizing bacteria included Bacillus theuringiensis (OL714386), Bacillus subtilis (MW246063), Bacillus pumilus (MW246062), and Bacillus velezensis (ON373966). The numbers in parentheses are the NCBI accession numbers, though it is noted that other microbes or bacteria may be used in other example embodiments.

B. theuringiensis was used for its zinc-solubilizing functions. B. subtilis was used for its phosphate-solubilizing functions. B. pumilus was used for its iron- and sulphur-solubilizing functions. B. velezensis was used for its potassium-solubilizing functions.

A loader was used to transfer material from the feedstock pile into a trommel screener. The particles that were too large to fall through the trommel screener (“overs”) were returned to the feedstock pile. The trommel screener was equipped with a 0.5 inch grid. The trommel screener also acted as a mixer, mixing the raw materials into a relatively homogenous mixture. The output of the trommel screener was added to a blended material stockpile.

The blended material stockpile had a moisture content of between 4% and 15%, in the stockpile, before the first drying process, and an average bulk density of 75 lb/ft3. Material from the blended material stockpile was transferred into a feed hopper using a loader. Material from the feed hopper was transferred into a charge hopper using a belt feeder and a conveyor. Material from the charge hopper was transferred into a ball mill using a screw feeder.

The ball mill was a 6′ by 8′ ball mill with a 100 HP motor drive. The ball mill micronized the material to 250 mesh before outputting the material to a granulator. The outputted material was transferred to the granulator using a chute to a first conveyor to a feed hopper and to a second conveyor.

In the granulator, a binding agent comprising 95% water and 5% molasses was introduced. The granulator was then used to produce bio-nutrient granules of a size between about 1 mm and about 4 mm in diameter. The bio-nutrient granules were transferred to a fluid bed dryer using a conveyor.

The fluid bed dryer was used to dry the bio-nutrient granules to have about 2% moisture. Care was taken to ensure the surface temperature of the bio-nutrient granules did not exceed 180° F., thus ensuring that the solubilizing bacteria were not killed.

The bio-nutrient granules were then passed to a Rotex® screener using a conveyor. The Rotex® screener was configured such that bio-nutrient granules of a size (e.g. diameter) larger than 4 mm (“overs”) or of a size smaller than 1 mm (“fines”) were separated and returned to the blended material stockpile.

A portion of the screened bio-nutrient granules were then passed to a drum coater using a bucket elevator. The drum coater was used to coat the bio-nutrient granules with a biological substance. The drum coater can also be used to apply dust control and/or anti-coating agents to the granules. Materials were transferred from the drum coater to a conveyor using another bucket elevator. The screened bio-nutrient granules that were not transferred to the drum coater were transferred to this same conveyor.

A portion of these bio-nutrient granules were passed into storage bins, awaiting transfer to a truck for distribution. A different portion were passed into supersacks via a conveyor, also awaiting transfer to a truck for distribution.

Although various components are described herein as stand-alone components, this disclose contemplates the combination of two or more components to the extent similar outcomes may be achieved. In one example embodiment, a micronizer may be configured to perform dryer functions as well as micronizing.

While the principles of this disclosure have been shown in various exemplary embodiments, many modifications of structure, arrangements, proportions, the elements, materials and components, used in practice, which are particularly adapted for a specific environment and operating requirements, may be used without departing from the principles and scope of this disclosure. These and other changes or modifications are intended to be included within the scope of the present disclosure and may be expressed in the following claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of any embodiment. In the claims, reference to an element in the singular is not intended to mean “one and only one” unless explicitly so stated, but rather “one or more.”

Moreover, when language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

Systems, methods and apparatus are provided herein. In the detailed description herein, references to “various exemplary embodiments”, “one embodiment”, “an embodiment”, “an exemplary embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S. C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for preparing a fertilizer, the method comprising:
mixing a biologically organic material and elemental sulphur with at least one of the rock phosphate and potash to form a mixture, wherein the biologically organic material comprises solubilizing microbes;
curing the elemental sulphur and at least one of rock phosphate and potash, in the mixture, using the solubilizing microbes, resulting in a production of organic acids and plant-available nutrients in the mixture;
mechanically micronizing the mixture to a particle size between about 1 μm and about 250 μm;
forming the mixture into a bio-nutrient granule having a size between about 1 mm and 4 mm in diameter; and
removing moisture from the bio-nutrient granule, wherein a surface temperature of the bio-nutrient granule does not exceed 180° F.

2. The method of claim 1, further comprising mixing the biologically organic material with at least one additive.

3. The method of claim 1, wherein forming the mixture into the bio-nutrient granule further comprises agglomerating the mixture into the bio-nutrient granule with a binder.

4. The method of claim 3, wherein the binder comprises an organic-based binder.

5. The method of claim 4, wherein the organic-based binder comprises at least one of molasses, a lignosulfate, or a high carbohydrate binder.

6. The method of claim 1, further comprising applying a coating to the bio-nutrient granule.

7. (canceled)

8. (canceled)

9. A fertilizer, comprising:
bio-nutrient granules, each bio-nutrient granule comprising a biologically organic material, elemental sulphur, and at least one of rock phosphate and potash;
wherein the biologically organic material comprises living solubilizing microbes; and
wherein each bio-nutrient granule comprises (in terms of percent by weight of coated dried bio-nutrient granules):
between about 1% to 3% of a binder;
between about 1% of a coating;
and one of:
(A) where the bio-nutrient granules comprise the biologically organic material, elemental sulphur and rock phosphate:
The biologically organic material: about 1% to 15%;
The rock phosphate: about 60%-80%;
The elemental sulphur: about 5%-20%;
(B) where the bio-nutrient granules comprise the biologically organic material, elemental sulphur and potash:
The biologically organic material: about 1% to 15%;
The potash: about 30%-50%;
The elemental sulphur: about 20%-40%; or
(C) where the bio-nutrient granules comprise the biologically organic material, elemental sulphur, rock phosphate and potash:
The biologically organic material: about 1% to 15%;
The rock phosphate: about 30%-50%;
The potash: about 20%-40%; and
The elemental sulphur: about 20%-35%.

10. The fertilizer of claim 9, wherein the biologically organic material is biologically active.

11. The fertilizer of claim 9, wherein at least one of the binder and the coating comprises a food source.

12. The fertilizer of claim 11, wherein the binder comprises an organic-based binder, wherein the organic-based binder comprises at least one of molasses, a lignosulfate, or a high carbohydrate binder.

13. (canceled)

14. The fertilizer of claim 9, wherein each bio-nutrient granule comprises a food source.

15. The fertilizer of claim 9, wherein the biologically organic material comprises at least one of a compost or seaweed extract; and wherein the bio-nutrient granule further comprises of at least one additive of boron, humate, lime and calcium.

16. (canceled)

17. (canceled)

18. (canceled)

19. The fertilizer of claim 9, wherein each bio-nutrient granule comprises a pH of between about 3.5 and about 6.8.

20. The fertilizer of claim 9, wherein each bio-nutrient granule comprises a porosity of up to 70%.

21. A system for preparing a fertilizer, the system comprising:
a mixer for mixing a biologically organic material with elemental sulphur and at least one of rock phosphate and potash, to form a mixture;
a micronizer operably connected to the mixer, wherein the micronizer receives the mixture and micronizes the mixture to form a micronized mixture;
a granulator operably connected to the micronizer, wherein the granulator forms the micronized mixture into bio-nutrient granules; and
a granule dryer operably connected to the granulator for receiving the bio-nutrient granules from the granulator, wherein the granule dryer removes moisture from the bio-nutrient granules, and wherein a surface temperature of the bio-nutrient granules does not exceed 180° F. during this moisture removing process.

22. (canceled)

23. The system of claim 21, wherein the mixer is configured to receive source material from a plurality of feedstock piles, and to provide the mixture to a blended material stockpile, wherein the mixer further mixes additives into the mixture.

24. (canceled)

25. The system of claim 21, further comprising a product dryer for receiving the mixture from the mixer, and for drying the mixture before providing it to a blended material stockpile.

26. (canceled)

27. (canceled)

28. (canceled)

29. The system of claim 21, further comprising a coater for applying a coating to the dried bio-nutrient granule.

30. The system of claim 21, wherein the elemental sulphur and the at least one of rock phosphate and potash, of the mixture are solubilized by solubilizing microbes of the biologically organic material while the mixture is in a blended material stockpile.

31. (canceled)

32. (canceled)

33. The system of claim 29, further comprising a screener for receiving the dried bio-nutrient granules from the granule dryer, wherein the screener is operably connected to a blended material stockpile, such that a portion of the bio-nutrient granules having a size less than about 1 mm or greater than about 4 mm in diameter is returned to the blended material stockpile, the screener further passing the bio-nutrient granules having a size between about 1 mm and 4 mm in diameter on to the coater.

34. (canceled)

35. (canceled)
